(19) United States
(12) Patent Application Publication
(10) Pub. No.: US 2023/0271838 A1
(43) Pub. Date: Aug. 31, 2023

(54) METHOD FOR ANCHORING METAL NANOPARTICLES TO CARBON NANOTUBES

(71) Applicant: NATIONAL RESEARCH COUNCIL OF CANADA, Ottawa (CA)

(72) Inventors: Jianfu DING, Ottawa (CA); Zhao LI, Orleans (CA); Chang GUO, Nepean (CA); Francois LAPOINTE, Gatineau (CA); Jianying OUYANG, Ottawa (CA); Patrick Roland Lucien MALENFANT, Orleans (CA)

(21) Appl. No.: 18/112,751

(22) Filed: Feb. 22, 2023

Related U.S. Application Data
(60) Provisional application No. 63/312,901, filed on Feb. 23, 2022.

(51) Int. Cl. C01B 32/174; B82Y 30/00; B82Y 40/00; G01N 27/30

(52) U.S. Cl. CPC C01B 32/174; B82Y 30/00; B82Y 40/00; G01N 27/308; C01B 2202/02

(57) ABSTRACT

A composite material suitable for use in sensing and catalysis applications with conjugated polymers non-covalently bound to the carbon nanotubes. The conjugated polymers have alternating aromatic (Ar) units and bipyridine (BPy) units. Metal nanoparticles having a size that is between about 0.3 nm and about 5 nm are bound to the conjugated polymers at respective BPy units, thereby anchoring the metal nanoparticles to the carbon nanotubes. Thus, a metal salt solution was added into the polymer/carbon nanotube solution to form a metal-BPy complex, which is in situ photo reduced to metal nanoparticles. Therefore, the formed nanoparticles are tightly anchored to the nanotube and can be self-regenerated by room light to offer the material a high performance and durability.

### CROSS-REFERENCE TO RELATED APPLICATIONS

This application claims the benefit of U.S. Provisional Application No. 63/312,901, filed on Feb. 23, 2022, the entire contents of which are incorporated herein by reference.

### FIELD OF THE INVENTION

The invention relates generally to composite materials, and more particularly to carbon nanotube (CNT) composite materials having highly dispersed metal nanoparticles anchored thereto via conjugated polymers.

### BACKGROUND

Composite materials may be formed by combining two or more constituent materials. By choosing the constituent materials, properties of the composite materials may be tailored. Carbon nanotubes (CNTs) may be combined with other materials to form functional composite materials.

### SUMMARY OF THE INVENTION

The following presents a simplified summary of various aspects of the present disclosure in order to provide a basic understanding of such aspects. This summary is not an extensive overview of the disclosure. It is intended to neither identify key or critical elements of the disclosure, nor delineate any scope of the particular embodiments of the disclosure or any scope of the claims. Its sole purpose is to present some concepts of the disclosure in a simplified form as a prelude to the more detailed description that is presented later.

In one aspect of the present disclosure, a conjugated polymer ligand is used to anchor a metal species to the surface of carbon nanotubes. Specifically, alternating copolymers of an aromatic unit (Ar) with a bipyridine unit (BPy) having the general structure,

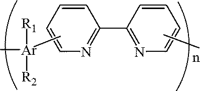

where Ar is an aromatic unit selected from the following group: naphthalene, anthracene, fluorene, carbazole, phenylene, furan, benzofuran, isobenzofuran, pyrrole, indole, isoindole, thiophene, bithiophene, benzothiophene, benzo[c]thiophene, imidazole, benzimidazole, purine, pyrazole, indazole, oxazole, benzoxazole, isoxazole, benzisoxazole, thiazole, benzothiazole, pyridine, bipyridine, quinolone, isoquinoline, pyrazine, quinoxaline, acridine, pyrimidine, quinazoline, pyridazine, cinnoline, phthalazine, tetrazine, triazine and benzothiadiazole, or combinations thereof, R1 and R2 are side chains of liner of branched C₁₀-C₂₄ aliphatic, oligo(ethoxy) or oligo(methoxy) groups. In an embodiment, Ar is fluorene with two dodecyl side chains at 9,9-position (9,9-di-n-dodecylfluorene). A specific and non-limiting example is poly(9,9-di-ndodecylfluorenyl-2,7-diyl-alt-2,2′-bipyridine-5,5′ or PF12BPy-5,5′).

The conjugated polymer is used to wrap CNTs, for instance single walled carbon nanotubes (SWCNTs), in a polar solvent medium, such as for instance tetrahydrofuran (THF). Metal ions are then added to the solution of the polymer wrapped CNTs in the form of a metal salt, such as the trifluoromethylsulfonate (OTf) salt, resulting in the metal ion being anchored to the CNTs by coordinating with the bipyridine (BPy) unit in the wrapping polymer, to form a complex.

In some embodiments the M-OTf polymer-CNT complex is formed in solution by adding the M-OTf into a solution of the polymer wrapped CNTs.

In some embodiments the M-OTf polymer-CNT complex is formed as a film by soaking a substrate coated with the polymer wrapped CNTs in a solution containing the M-OTf.

In another aspect of the present disclosure, a composition comprises: a carbon nanotube; a conjugated polymer non-covalently bound to the carbon nanotube, the conjugated polymer having alternating aromatic (Ar) units and bipyridine (BPy) units; and metal nanoparticles, each having a size between about 0.3 nm and about 5 nm, bound to the conjugated polymer at respective BPy units thereof.

In some embodiments the carbon nanotube is a single-walled carbon nanotube (SWCNT).

In some embodiments the metal nanoparticles each have a size that is larger than about 0.3 nm and smaller than about 1 nm.

In some embodiments the conjugated polymer has the general formula I:

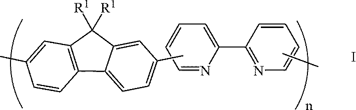

wherein: R¹ and R² are independently C₁₀-C₂₄ branched or unbranched aliphatic, oligo(ethoxy) or oligo(methoxy) groups; and n is between 5 and 500.

In some embodiments linkage to BPy is at the 5,5′ positions.

In some embodiments Ar is selected from the group consisting of: naphthalene, anthracene, fluorene, carbazole, phenylene, furan, benzofuran, isobenzofuran, pyrrole, indole, isoindole, thiophene, bithiophene, benzothiophene, benzo[c]thiophene, imidazole, benzimidazole, purine, pyrazole, indazole, oxazole, benzoxazole, isoxazole, benzisoxazole, thiazole, benzothiazole, pyridine, bipyridine, quinolone, isoquinoline, pyrazine, quinoxaline, acridine, pyrimidine, quinazoline, pyridazine, cinnoline, phthalazine, tetrazine, triazine, benzothiadiazole, and combinations thereof.

In some embodiments the metal nanoparticles are nanoparticles of a metal selected from the group consisting of: Ag, Cu, Co, Ni, Mn, Fe, Zn, In, Pd, Cr, Sn, Cd, Ir, and Ru.

In some embodiments Ar is 9,9-di-n-dodecylfluorene, linkage to BPy is at the 5,5′ positions, and the metal nanoparticle is a silver nanoparticle or a copper nanoparticle having a size in the range between about 0.3 nm and about 1.5 nm.

In another aspect of the present disclosure, a method of making a composition, the method comprising: non-covalently binding a conjugated polymer to a carbon nanotube to form a polymer-wrapped composite, the conjugated polymer comprising alternating aromatic (Ar) units and bipyridine (BPy) units; in a solution, adding metal ions to bind with the BPy units of the conjugated polymer; irradiating the solution with light to reduce the metal ions and form seed locations for nanoparticle growth at the BPy units; and growing nanoparticles at the seed locations to a size in the range between about 0.3 nm and about 5 nm.

In some embodiments the carbon nanotube is a single-walled carbon nanotube (SWCNT).

In some embodiments growing the nanoparticles comprises growing the nanoparticles to a size that is larger than about 0.3 nm and smaller than about 1 nm.

In some embodiments the step of non-covalently binding conjugated polymers to carbon nanotubes includes dispersing the conjugated polymer and the carbon nanotube in a non-polar solvent.

In some embodiments the non-polar solvent is toluene.

In some embodiments the polymer-wrapped composite is separated from the non-polar solvent and the separated polymer-wrapped composite is redispersed in tetrahydrofuran to form the solution.

In some embodiments the metal ions (M) are added to the solution to produce a molar ratio [M]/[BPy] of 0.1 to 50.

In some embodiments the molar ratio [M]/[BPy] is 0.4 to 5.

In some embodiments the conjugated polymer has the general formula I:

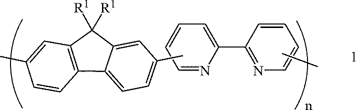

wherein:
R¹ and R² are independently C₁₀-C₂₄ branched or unbranched aliphatic, oligo(ethoxy) or oligo(methoxy) groups; and
n is between 5 and 500.

In some embodiments Ar is selected from the group consisting of: naphthalene, anthracene, fluorene, carbazole, phenylene, furan, benzofuran, isobenzofuran, pyrrole, indole, isoindole, thiophene, bithiophene, benzothiophene, benzo[c]thiophene, imidazole, benzimidazole, purine, pyrazole, indazole, oxazole, benzoxazole, isoxazole, benzisoxazole, thiazole, benzothiazole, pyridine, bipyridine, quinolone, isoquinoline, pyrazine, quinoxaline, acridine, pyrimidine, quinazoline, pyridazine, cinnoline, phthalazine, tetrazine, triazine, benzothiadiazole, and combinations thereof.

In some embodiments the metal nanoparticles are nanoparticles of a metal selected from the group consisting of: Ag, Cu, Co, Ni, Mn, Fe, Zn, In, Pd, Cr, Sn, Cd, Ir, and Ru.

### BRIEF DESCRIPTION OF THE DRAWINGS

Exemplary embodiments will be described in accordance with the drawings, which are not drawn to scale, and in which:

FIG. 1 is a simplified diagram illustrating the formation of an Ag-PFBPy/CNT composite material according to an embodiment.

FIG. 2 is a simplified diagram showing the system that was used in the sensor testing study.

FIG. 3A shows ultraviolet-visible absorption spectra obtained during Ag-OTf titration of solutions containing PFBPy/CNT between 200 nm and 2250 nm.

FIG. 3B shows ultraviolet-visible absorption spectra obtained during Ag-OTf titration of solutions containing PFBPy/CNT between 1550 nm and 1750 nm.

FIG. 3C shows ultraviolet-visible absorption spectra obtained during Ag-OTf titration of solutions containing PFBPy/CNT between 250 nm and 600 nm.

FIG. 3D shows ultraviolet-visible absorption spectra obtained during Ag-OTf titration of solutions containing PFDD/CNT between 200 nm and 2250 nm.

FIG. 3E shows ultraviolet-visible absorption spectra obtained during Ag-OTf titration of solutions containing PFDD/CNT between 1550 nm and 1750 nm.

FIG. 4A shows ultraviolet-visible absorption spectra for non-doped films, doped films, and doped films after soaking in EtOH for 10 minutes for Ag-OTf doping of PFBPy/CNT film.

FIG. 4B shows ultraviolet-visible absorption spectra for non-doped films, doped films, and doped films after soaking in EtOH for 10 minutes for Ag-OTf doping of PFDD film/CNT.

FIG. 4C shows ultraviolet-visible absorption spectra for non-doped films, doped films, and doped films after soaking in EtOH for 10 minutes for H-OTf doping of PFBPy/CNT film.

FIG. 4D shows ultraviolet-visible absorption spectra for non-doped films, doped films, and doped films after soaking in EtOH for 10 minutes for Ag-OTf doping of PFBPy film.

FIG. 5A is a simplified diagram depicting the reaction mechanism for Ag⁺ reduction on carbon nanotubes in air under light irradiation.

FIG. 5B is a simplified energy level diagram for the reaction mechanism shown in FIG. 5A.

FIG. 6 shows cyclic voltammograms obtained for samples coated on a Pt electrode: A) PFDD; B) PFDD/CNT; C) Ag-PFDD/CNT; D) PFPBy; E) PFPBy/CNT; F) Ag-PFPBy/CNT.

FIG. 7 shows a comparison of the XPS survey spectra of six films: A) Ag-PFBPy/CNT; B) PFBPy/CNT; C) PFBPy; D) Ag-PFDD/CNT; E) PFDD/CNT; F) PFDD.

FIG. 8A shows high resolution XPS curves for C1s of PFBPy, PFBPy/CNT and Ag-PFBPy/CNT.

FIG. 8B shows high resolution XPS curves for N1s of PFBPy, PFBPy/CNT and Ag-PFBPy/CNT.

FIG. 8C shows high resolution XPS curves for Ag3d of Ag-PFDD/CNT and Ag-PFBPy/CNT.

FIG. 9A is an ADF-STEM image of an Ag-PFBPy/CNT composite.

FIG. 9B is an ADF-STEM image of an Ag-PFDD/CNT composite.

FIG. 9C is an enlarged image of the area within the white square of FIG. 9A.

FIG. 9D is a density graph of the AgNP chain shown in FIG. 9C.

FIG. 9E is a HRTEM images of an Ag-PFBPy/CNT composite to show the wall of nanotubes and the wrapping polymer.

FIG. 9F is a high magnification image of an Ag-PFBPy/CNT using a low pass filter to show the wall of nanotubes and the very small silver nanoparticles on the wall.

FIG. 10 is a conventional HRTEM image of an Ag-PFBPy/CNT composite, showing highly isolated AgNPs with a size of ~3 nm.

FIG. 11A shows sensing profiles of a chemiresistor to moisture in air at 50% RH by comparison of the response (ΔG/G0) curve of Ag/PFBPy/CNT and PFBPy/CNT devices to an air sequence with lower RH (48.1, 46.3, 44.6, 43.1 and 41.7%).

FIG. 11B shows an enlarged view of one of the peaks shown in FIG. 11A.

FIG. 12 shows an energy diagram of AgNP and CNT in the Ag-PFBPy/CNT and Ag-PFDD/CNT composite materials: A) before contact; B) after contact; and C) after exposure to wet air.

FIG. 13 shows transfer curves of FET devices with 20 µm channel lengths of A) PFBPy/CNT and Ag-PFBPy/CNT in N₂; B) PFDD/CNT and Ag-PFDD/CNT in N₂; C) PFBPy/CNT and Ag-PFBPy/CNT in air; and D) PFDD/CNT and Ag-PFDD/CNT in air.

FIG. 14 shows the sensing profile of Cu-PFBPy/CNT chemiresistors to ethylene gas at concentration of 50, 40, 30, 20 and 10 ppm in air at 50% RH of: A) Cu(I)-PFBPy-5,5′/CNT; B) Cu(I)-PFBPy-6,6′/CNT; and C) Cu(II)-PFBPy-5,5′/CNT.

### DETAILED DESCRIPTION

Due to their excellent electron conductivity, mechanical strength, chemical stability, and large surface area, carbon nanotubes (CNTs) have attracted considerable attention as a matrix for loading metal species for catalysis and sensing applications, as well as for water cleaning, energy harvesting and energy storage applications, etc. In this type of composite material, the metal species provides specific active sites for the desired functionality, whilst the CNT network or structure offers a robust mechanical support and an efficient charge transport system to enable highly efficient transduction performance for these applications. Typically, the metal species is in the form of metal nanoparticle (NPs).

NP/CNT nanocomposites can be formed in at least two different ways. One approach involves directly depositing metal onto the CNTs by vacuum or chemical deposition, which results in metal nanoparticles being attached to the CNT structure without any chemical linkage. Another approach involves attaching the metal to the CNT structure via a chemical linkage, which may be either covalent or non-covalent. The chemical linkage approach has the potential to produce metal/CNT composite materials that are more stable than those produced using the direct deposition approach, and with a more uniform and higher degree of dispersion of the metal species, which may even be at the atomic level. This level of metal dispersion may be desirable e.g., for applications including sensing and catalysis.

Covalent linkage is usually achieved by anchoring a metal species via a chemical bond, such as -S- bond for instance an Au-surface, or for most other metals by linking a metal complex onto the CNT surface by a chemical bond.

Non-covalent linkage may be achieved by attaching a metal complex of a large, coplanar conjugated ligand, such as for instance phthalocyanine, onto the surface of the CNT. In this case, the π-π interaction between the ligand and CNT structure provides a force to anchor the metal to the surface of the CNT structure. In a non-covalently linked system, the sensing and catalytic capability of the composite material is dependent on the charge that can be transferred between the metal species and the CNT structure via the organic ligand. A high charge transfer between the metal species and the organic ligand may result in an excellent sensing capability of the metal/CNT composite materials. The charge transfer capability between the organic ligand and the CNT structure, based on their π-π interaction, can be promoted by the use of a ligand with a large co-planner structure. Furthermore, this type of metal/CNT composite material can exhibit a very high degree of metal dispersion that results in a close electrical contact with the highly conductive CNT network.

Unfortunately, due to the limited size that is typical of this type of organic ligand, the strength of the interaction with the CNT structure is correspondingly limited and the resulting metal/CNT composite materials for real applications are not sufficiently robust and have limited lifetimes. Various approaches have been attempted to increase the strength of this interaction.

Introducing functional groups such as amines into the organic ligand have been found to enhance the interaction of the ligand with the CNT structure, resulting in improved stability as demonstrated by Zhang et al. (Xing Zhang, Zishan Wu, Xiao Zhang, Liewu Li, Yanyan Li, Haomin Xu, Xiaoxiao Li, Xiaolu Yu, Zisheng Zhang, Yongye Liang, Hailiang Wang, “Highly selective and active CO2 reduction electro-catalysts based on cobalt phthalocyanine/ carbon nanotube hybrid structures,” Nat. Commun. 2016, 8, 14675, 1-8), the entire contents of which are incorporated herein by reference.

As an alternative, a chemical bonded complex/CNT system, where the metal in the complex was linked to the CNT surface by a covalent bond on the ligand, has been tested for improved durability by Nosek et al. (Magdalena Nosek, Jani Sainio, Pekka M. Joensuu, “2,2′-bipyridine-functionalized single-walled carbon nanotubes: The formation of transition metal complexes and their charge transfer effects,” Carbon 129 (2018) 175-182), the entire contents of which are incorporated herein by reference. However, this type of chemical linkage usually deteriorates the close face-to-face packing of the complex on the CNTs surface, resulting in a reduced π-π interaction between ligand and CNTs. This reduced π-π interaction prevents an efficient charge transfer between metal and CNTs, and thereby reduce their efficiency in sensing and catalysis applications.

As yet another alternative, Yoon et al. (Bora Yoon, Sophie F. Liu, and Timothy M. Swager, Surface-Anchored Poly(4-vinylpyridine)- Single-Walled Carbon Nanotube Metal Composites for Gas Detection, Chem. Mater. 2016, 28, 5916-5924), the entire contents of which are incorporated herein by reference, proposed using a polymer wrapping in which an organic ligand as a side chain of a polymer was used to wrap nanotubes. The resulting Ag/pyridine complex in poly(4-vinylpridine) was anchored to the nanotubes by polymer wrapping and exhibited a good sensing capability to ammonia gas.

A similar metal anchoring strategy was attempted by Pan et al. (Chengjun Pan, Luhai Wang, Wenqiao Zhou, Lirong Cai, Dexun Xie, Zhongming Chen, Lei Wang, Preparation and Thermoelectric Properties Study of Bipyridine-Containing Polyfluorene Derivative/SWCNT Composites, Polymers 2019, 11, 278, 1-10), the entire contents of which are incorporated herein by reference. A metal salt dissolved in methanol was added to a chlorobenzene solution of a conjugated polymer (PFBPy) having the following general structure,

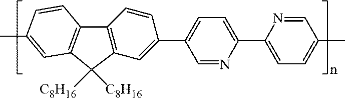

where the bipyridine moiety is in the 5,5′ configuration. A M-PFBPy colloid solution was obtained, which was added to a solution of single wall carbon nanotubes (SWCNTs) in chlorobenzene. The resulting product was an unstable solution of the M-PFBPy-SWCNT, due to the relatively short C₈ sidechains on the PFBPy polymer. Additionally, the process described by Pan et al. achieved poor distribution of the metal, with no direct contact with the SWCNT structure at the molecular level, making the material poorly suited for sensing and catalysis applications.

Described hereinbelow are embodiments of composite materials having metal nanoparticles anchored to carbon nanotubes via conjugated polymers, methods for producing the same, and sensors incorporating the same. Certain embodiments relate to a gas (e.g., water vapor, ethylene, etc.) sensor that uses a composition comprising carbon nanotubes (e.g., single-walled carbon nanotubes, or “SWCNTs”, or alternatively double-walled carbon nanotubes “DWCNTs” or multiple-wall carbon nanotubes “MWCNTs” may be used) having anchored metal nanoparticles as a sensing material. The sensing material may be placed in between interdigitated electrodes of a sensor. When analyte gas adsorbs to the sensing material, the electronic state of the material is changed resulting in a change in resistivity that is proportional to the amount of analyte gas adsorbed. This change in resistivity can be measured via a number of resistivity measurement techniques (e.g., voltammetry). The sensor material can be regenerated by flushing with analyte-free gas.

Definitions: SWCNTs, are semiconducting single-walled carbon nanotubes with diameter ranged from 0.6 ~1.8 nm, prepared by various techniques including CVD, Laser ablation, plasma, and arc-discharge etc. SWCNTs with a high semiconducting purity (>99%) are used, which are enriched by CPE or related techniques.

In the disclosed composite materials, the anchored metal nanoparticles can act as a selector for sensing a desired analyte. A wide range of composite materials loaded with different metal nanoparticles may be produced using the general methods and techniques that are described herein, for use in sensing different analytes. Additionally, such materials may be used to catalyze different reaction. These composite materials are structurally robust due to the strength that is imparted by the structure of the CNTs (e.g., SWCNTs) and the strong π-π interaction that is formed between the CNTs and the conjugated polymer. This interaction, in addition with the complex structure between metal and the polymer, will enable a very tight anchoring of the metal NPs to CNTs

In some embodiments, a metal anchoring system for carbon nanotubes uses a conjugated polymer with a ligand in the conjugated main chain. Specifically, an alternating copolymer of fluorene with bi-pyridine (BPy), i.e., poly(9,9-di-n-dodecylfluorenyl-2,7-diyl-alt-2,2′-bipyridine-5,5′) (PF12BPy-5,5′, or PFBPy), having the structure shown below:

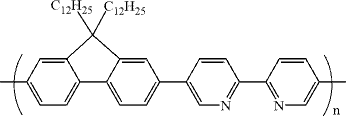

Without being bound by theory, the 5,5′- linkage of the BPy unit with the fluorene co-monomer results in a fully conjugated structure of the polymer main chain, which provides two effects to promote charge transfer between the anchored metal and the CNTs: (1) chelating of metal with BPy in the polymer facilitates charge flow between the metal and the polymer; and (2) an efficient π-π interaction between the large coplanar conjugated main chain of the polymer and the CNTs promotes charge transfer between the polymer and the CNTs. The 5,5′-BPy linkage of the polymer contributes to maintaining the straight coplanar main chain structure after reaction with the metal to form a complex, and thus the strong π-π interaction between the polymer and CNTs remains.

The ability of the polymer to maintain its conformation after being complexed with the metal plays an important role in preserving the strong polymer-CNT interaction in the composite material. For example, an analogue fluorene/BPy alternating copolymer with 6,6′-bipyridine linkage has been observed to demonstrate a high capability in sc-SWCNT enrichment, indicating a strong π-π interaction with the CNTs. However, a recent work showed that the addition of metal ions into a solution containing the polymer wrapped CNTs rapidly strips the polymer off the CNTs (Yongho Joo, Gerald J. Brady, Matthew J. Shea, M. Belen Oviedo, Catherine Kanimozhi, Samantha K. Schmitt, Bryan M. Wong, Michael S. Arnold, Padma Gopalan, Isolation of Pristine Electronics Grade Semiconducting Carbon Nanotubes by Switching the Rigidity of the Wrapping Polymer Backbone on Demand, ACS Nano, 2015, 9, 10203-10213), the entire contents of which are incorporated herein by reference. This is believed to occur because the coordinating reaction with the metal forced the BPy unit to adopt the cis-conformation, bending the polymer main chain to 60° at the BPy unit and thereby damaging the compact packing of the polymer on CNTs.

The metal nanoparticles are highly dispersed in the M-PFBPy/CNT composite material and exhibit a narrow size distribution and small nanoparticle size. For instance, the size of the metal nanoparticles may be in the range between about 0.3 nm and about 5 nm. An average NP size of 0.6 nm and average separation between the two adjacent NPs of ~1.7 nm can be achieved. This spacing agrees with the distance between two adjacent BPy units in the polymer chain, indicating good metal coverage of the composite material network. The size of the formed AgNPs, which is well-controlled at sub-nm levels, provide them with an energy level comparable to that of the SWCNTs, which enabled a good charge transfer therebetween, as discussed in more detail below.

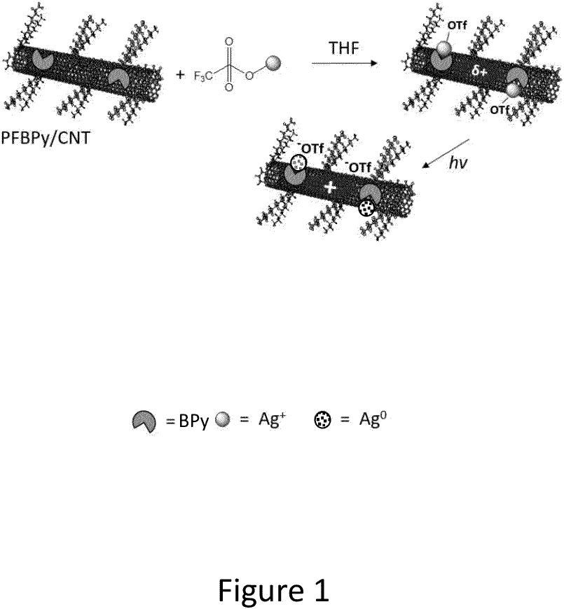

Referring now to FIG. 1, shown is a simplified diagram illustrating the formation of a composite material according to an embodiment. In this specific example, silver nanoparticles (NPs) are anchored to carbon nanotubes via the conjugated polymer PFBPy to form a composite material Ag-PFBPy/CNT. As shown in FIG. 1, the Ag-PFBPy/CNT composite solution was prepared by adding the trifluoromethylsulfonate salt of silver (Ag-OTf) into a PFBPy/CNT solution. This process leads to the formation of Ag-BPy complex in the PFBPy polymer on the CNT surface. Irradiation with light, e.g., daylight, having sufficient energy to excite electrons in the CNT subsequently reduces Ag⁺ in the Ag-BPy complex to Ag⁰. The formed Ag⁰ acts as a seed for further Ag⁺ deposition and reduction to form a silver nanoparticle (AgNP).

As is discussed in more detail below, anchoring the metal to the CNTs using a conjugated polymer containing the BPy unit (e.g., PFBPy) results in much more efficient reduction of Ag⁺ compared to a similar system using a conjugated polymer without the BPy unit (e.g., Poly(9,9-di-n-dodecylfluorenyl-2,7-diyl) or PFFD). Furthermore, this anchoring effect provided close electrical contact between the AgNPs and the highly conductive CNT network, as evidenced by HTEM, CV, and UV studies, leading to improved sensing properties of the prepared composite material.

### Preparation of Metal/Polymer/SWCNT Composite

### Ag-PFBPy/CNT Composite

A PFDD/CNT composite was prepared from a laser SWCNT sample using the conjugated polymer exchange (CPE) method described previously by Ding et al. (Jianfu Ding, Zhao Li, Jacques Lefebvre, Fuyong Cheng, Girjesh Dubey, Shan Zou, Paul Finnie, Amy Hrdina, Ludmila Scoles, Gregory P. Lopinski, Christopher T. Kingston, Benoit Simard, Patrick R. L. Malenfant, Enrichment of large-diameter semiconducting SWCNTs by polyfluorene extraction for high network density thin film transistors. Nanoscale, 2014, 6, 2328-2339, the entire contents of which are incorporated herein by reference, and Jianfu Ding, Zhao Li, Jacques Lefebvre, Fuyong Cheng, Jeffrey L. Dunford, Patrick R. L. Malenfant, Jefford Humes, Jens Kroeger. A hybrid enrichment process combining conjugated polymer extraction and silica gel adsorption for high purity semiconducting single-walled carbon nanotubes (SWCNTs). Nanoscale, 2015, 7, 15741 - 15747), the entire contents of which are incorporated herein by reference. The weight ratio of polymer to SWCNTs in the solution obtained from CPE was 1/1, which was adjust to 2.5/1 in the final PFDD/SWCNT inks for this study.

The PFBPy/SWCNT composite was prepared from the PFDD/CNT composite with a 1/1 weight ratio in a ligand exchange process by addition of PFBPy with 10 times the SWCNT weight to the PFDD/CNT solution in toluene. The resulting mixture was sonicated in an ultrasonic bath for 2 hours to ensure a complete polymer exchange. After sonication, the mixture was filtered to remove PFDD from solution. A completely PFBPy wrapped composite was obtained by repeating this process once more to generate a composite with a PFBPy/CNT weight ratio of 2.5, after a film recovered from a second filtration step was thoroughly rinsed with the solvent (toluene) to remove free polymer.

The PFBPy/CNT composite was dissolved in THF, and a dilute Ag-OTf solution in THF was added to achieve a 0.4 [Ag]/[BPy] molar ratio, which is alternatively expressed as a 0.0183 [Ag]/[CNT] molar ratio (where [CNT] = carbon molar concentration of SWCNT). This procedure yielded an Ag-PFBPy/CNT composite solution. For comparison, an Ag-PFDD/CNT composite solution in THF was also prepared by adding the dilute Ag-OTf solution into a 2.5/1 (weight ratio) PFDD/CNT solution at 0.0183 of [Ag]/[CNT].

### Cu(I)-PFBPy-5,5′/CNT

Similarly, the Cu-PFBPy/CNT composite was also prepared by adding a Cu-OTf (Cu(I) trifluoromethanesulfonate benzene complex) solution in THF to the PFBPy/CNT composite solution at a 1/1 [Cu]/[BPy] molar ratio under day light.

### Characterization Parameters

The following parameters were used to characterize the various composite products and starting materials.

### Absorption Spectroscopic Study

Absorption spectra of the polymer, polymer/CNT composite, and Ag-polymer/CNT composite in THF were collected on a UV-Vis-NIR spectrometer (Cary-5000) in a range from 200 to 3200 nm.

### Transmission Electron Microscopy (TEM)

A small drop of a diluted Ag-PFDD/CNT or Ag-PFBPy/CNT composite solution in THF was placed on a 200 mesh TEM copper grid coated with a Lacey carbon film, and the excess solution on the surface was immediately removed by touching the edge with a filter paper. A FEI Titan 80-300 TEM operated at 300 keV and equipped with a CEOS aberration corrector for the probe forming lens and a monochromated field-emission gun was used to acquire both high-resolution TEM (HRTEM) and annular dark-field (ADF) images. HRTEM has better contrast for imaging the carbon nanotubes and polymer and was used to study the polymer/CNT composite sample. ADF images were collected using a high-angle annular dark-field (HAADF) Fischione detector in scanning transmission electron microscopy (STEM) mode. This technique provides signal intensity related mainly to the atomic number (Z) and the thickness of the region analyzed. When combined with an aberration corrector, ADF-STEM can reach a sub-Angstrom resolution and single-atom sensitivity, and it is used to image Ag atom and its nanoparticles.

### X-Ray Photoelectron Spectroscopy (XPS)

For XPS analysis, 6 film samples were coated on an aluminum strip by drop-casting the corresponding solutions in THF. The samples are: PFDD film, PFDD/CNT composite, Ag-PFDD/CNT composite (0.0183 of [Ag]/[CNT] molar ratio), PFBPy film, PFBPy/CNT composite, and Ag-PFBPy/CNT composite (0.0183 of [Ag]/[CNT] molar ratio). After coating on the aluminum strip, the samples were heated in an oven at 130° C. for 10 min to promote a thorough solvent evaporation. The XPS analyses were carried out with a Kratos Axis Ultra DLD X-ray photoelectron spectrometer using a monochromatic Al Kα X-ray source (12 mA, 15 kV) and analysis area of 300 ×700 microns. XPS can detect all elements except hydrogen and helium to a depth of 5-7 nanometers and has detection limits ranging from 0.1 to 0.5 atomic percent, depending on the element. A Kratos charge neutralizer system was used on all specimens. Survey scan analyses (pass energy of 160 eV) were carried out at 3 different spots on each sample in order to check for uniformity, and the spectra were averaged for a better S/N ratio. High resolution analysis was performed on a single spot in each sample (energy of 160 eV). Spectra were corrected to the main line of the C1s spectrum (polymeric carbon) set to 285 eV and were analyzed using CasaXPS software.

### Cyclic Voltammetry (CV)

CV was performed in acetonitrile using a gastight cell on a Solartron SI 1287 potentiostat. Measurements were carried out at a scan rate of 50 mV/s at a temperature of 20° C. A three-electrode configuration was used with a silver wire quasi-reference electrode and a platinum (Pt) wire as the counter electrode. A platinum disk (diameter 1 mm) sealed in a soft glass rod was employed as the working electrode, where the sample was coated by adding a small drop of solution. After drying, the electrode with the coated film was heated at 80° C. for 1 minutes, and was placed, along with the counter electrode and the quasi-reference electrode, into the cell. The cell was then loaded with tetrabutylammonium hexafluorophosphate (Bu₄NPF₆, Fluka, electrochemical grade) and vacuum-dried at 80° C. for 20 minutes. About 4 ml of acetonitrile (HPLC grade) was distilled (over CaH₂) into the cell to produce a 0.1 M Bu₄NPF₆ solution. The CV curves were recorded by scanning the potentials versus the Ag quasi-reference electrode.

### TFT and Sensor Test

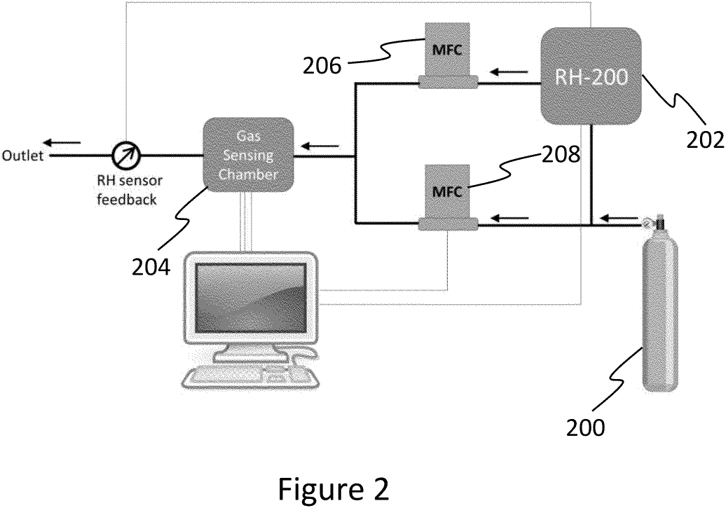

Testing was performed on Fraunhofer chips of 4×4 devices with 4 different channel lengths (2.5, 5.0, 10, and 20 µm) and 1 mm channel width. The active layer was coated by placing a drop of one of the solutions in the solvent atmosphere and waiting for 10 min, then the excess of solution was drained, and the film was annealed at 200° C. overnight in a glovebox to remove moisture and residual oxygen. The test was conducted by scanning the gate voltage from -10 V to 10 V and I-V curve was recorded in the glovebox. Humidity sensor testing was performed in a sensor testing chamber in chemiresistor mode, in a setup as illustrated in FIG. 2. The sensing device was prepared by coating the sample solution following the same procedure as for the TFT preparation, but on an Ossila chip containing 5 identical TFT devices with 30 µm channel length and 1 mm channel width in an interdigitated configuration. During the testing, dry air from a cylinder 200 was connected to a RH-200 Relative Humidity Generator 202 (L&C Science and Technology), and a constant flow of 250 standard cubic centimeters per minute (sccm) air at a RH of 50% was introduced into the chamber 204 controlled by a mass flow controller 206 as carry gas. A dry air pulse of 10 seconds followed by a 60 second gap was introduced into the sensing chamber 204 by another mass flow controller 208 at a flow rate of 10, 20, 30, 40, 50 sccm, corresponding to a corrected RH level at 48.1, 46.3, 44.6, 43.1 and 41.7%.

### Characterization Results

### Absorption Spectroscopic Study

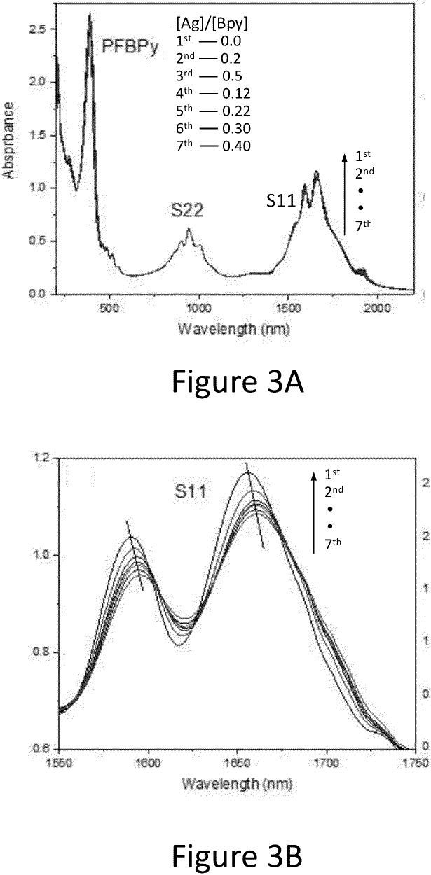

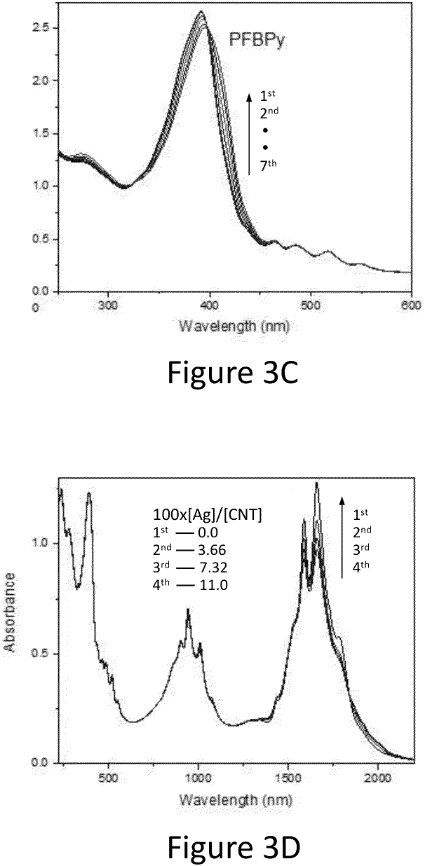

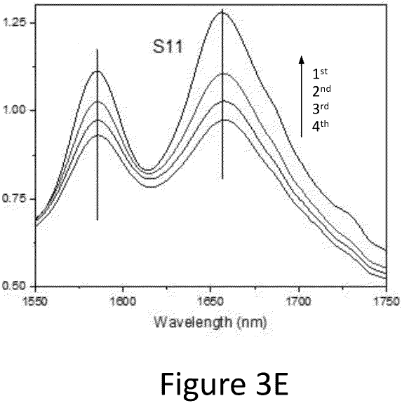

FIGS. 3A-3E show the variation of the absorption spectra of various solutions during titration with Ag-OTf. In particular, FIG. 3A shows the absorption spectra of PFBPy/CNT in THF solution during titration with Ag-OTf, under dimmed room light, in the range 200 to 3200 nm. FIG. 3B shows the same spectra in the range 1550 to 1750 nm and FIG. 3C shows the same spectra in the range 250 to 600 nm. FIG. 3D shows the absorption spectrum of PFDD/CNT in THF solution with titration of Ag-OTf in the range 200 to 3200 nm. For the PFDD/CNT solutions, no change was observed immediately after addition of aliquots of Ag-OTf and therefore the solutions were placed in sunlight for 10 minutes after addition of the Ag-OTf prior to obtaining the spectra. FIG. 3E shows the same absorption spectra of the PFDD/CNT solutions in the range 250 to 600 nm.

Now referring specifically to FIGS. 3A to 3C, three major absorption bands were observed in the range from 200 to 3200 nm for the PFBPy/CNT sample during titration with Ag-OTf. The PFBPy polymer absorption peak is at ~390 nm, and the S22 and S11 bands of CNTs are at ~938 nm and ~1650 nm respectively. Due to the multiple chirality nature of the CNTs, the S11 and S22 bands consist of multiple peaks. During Ag-OTf titration, both the polymer absorption peak and the S11/S22 bands of the CNTs displayed a redshift with increasing titration with Ag-OTf, as shown most clearly in FIGS. 3B and 3C. The redshift of the polymer peak indicates an increase of the effective conjugation length of the polymer main chain. This is associated with a higher coplanar confirmation of the BPy unit in the polymer when it becomes coordinated with Ag⁺. FIG. 1A shows that in addition to being redshifted the S11 and S22 bands also broadened, with the peak maximum being reduced but the integrated peak intensity remaining unchanged as the amount of Ag-OTf titrated increased. This is shown most clearly in FIG. 1B for the S11 bands. It is commonly accepted that this redshift is associated with a change in dielectric screening effect of the wrapping polymer due to the Ag⁺ chelating with the BPy unit in PFBPy. Combined with the π-π interaction of the polymer with CNTs, this interaction produces a tight anchoring of Ag to CNT to promote electron flow between silver and CNTs.

For comparison, corresponding absorption spectra were also obtained during Ag-OTf titration of PFDD/CNT. As shown in FIGS. 3D and 3E, these absorption spectra differ significantly from the PFBPy/CNT absorption spectra. In the PFDD/CNT absorption spectra, which were obtained after prolonged exposure (about 10 min) to sunlight (110 W/m²), peak intensity changes were observed as shown in FIG. 3D, and most clearly in FIG. 3E. This intensity change is attributed to CNT doping by the light catalyzed Ag⁺ reduction, as will be discussed in more detail below. In this composite, the dielectric screening change of the wrapping polymer does not exist due to the lack of BPy coordination, and thus only a direct electron injection to Ag⁺ from the conducting band of the CNTs occurs. It is worth noting that a similar reduction can be observed in the PFBPy/CNT solutions when the samples are subjected to irradiation with light, and the speed is about 100 times higher than in the PFFD/solutions.

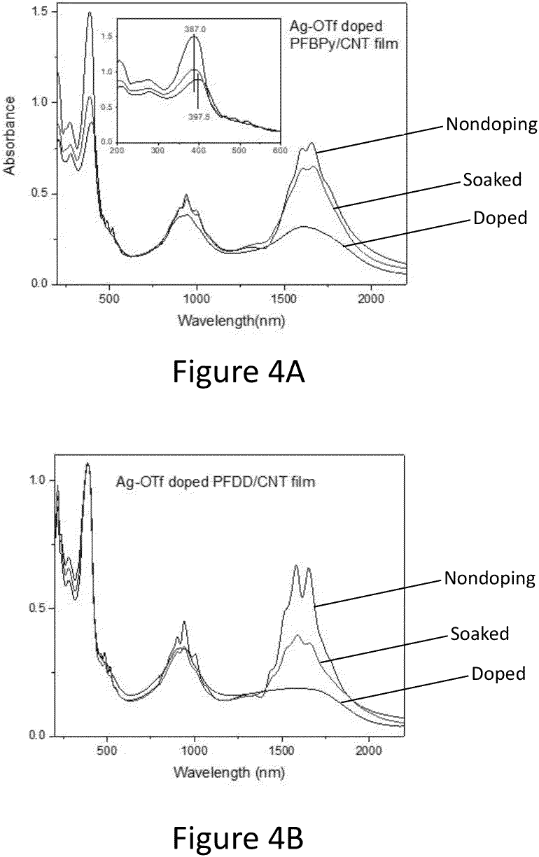

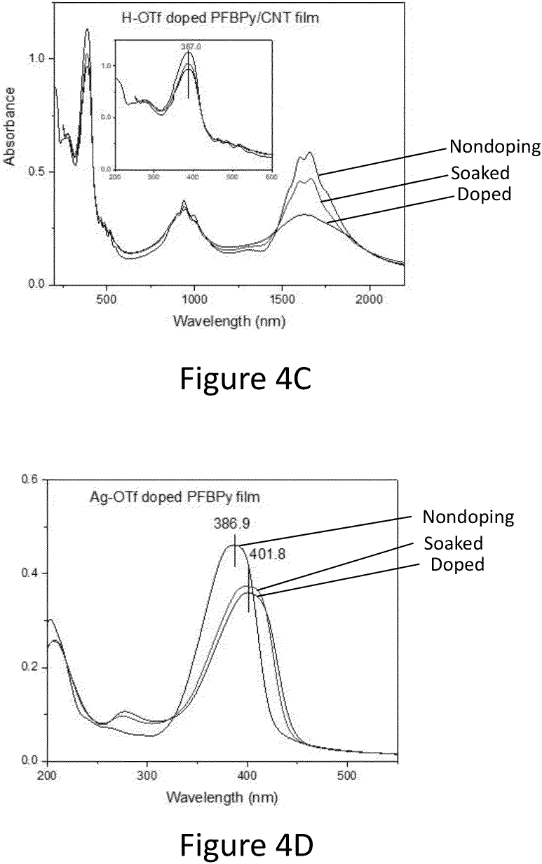

In a TFT or sensor device, SWCNTs as the active material may take the form of a thin solid film, and thus the Ag-OTf doping effect in solid samples was also studied by coating the polymer/CNTs composite solutions and their Ag-OTf doped solutions onto a quartz slide to form solid films. Their absorption spectra were collected and compared in FIGS. 4A to 4C. FIG. 4A shows the variation of the absorption spectra of the PFBPy/CNT composite film before doping, after doping at 0.4[Ag]/[BPy] ratio, and after de-doping by EtOH soaking. FIG. 4B shows the corresponding absorption spectra of the PFDD/CNT composite film before doping, after doping at 0.4[Ag]/[BPy] ratio, and after de-doping by EtOH soaking. FIG. 4C shows the corresponding absorption spectra of the PFBPy/CNT composite film before doping, after doping by soaking in H-OTf solution, and after de-doping by EtOH soaking. In this test, the PFBPy/CNT or PFDD/CNT composite solutions at a polymer/CNT weight ratio of 2.5/1 were added with Ag-OTf or H-OTf solution at 0.0183 of [Ag]/[CNT] or [H]/[CNT], corresponding to 0.4 eq Ag⁺ or H⁺ to BPy. The films were prepared by coating the solution on quartz plates and annealed at ~ 50° C. for 10 min. The de-doped films were prepared by soaking in EtOH for 10 min and drying at 150° C. for 10 min. For comparison, FIG. 4D shows the corresponding absorption spectra of PFBPy film without CNT before doping, after doping at 0.4[Ag]/[BPy] ratio, and after de-doping by EtOH soaking.

The test showed that the Ag-OTf doped film samples have dramatically broadened S11 and S22 peak with the intensity reduced to less than half when compared with the film sample without Ag-OTf doping, as shown in FIGS. 4A and 4B. This result confirmed that the Ag-OTf doped solid samples of both PFBPy/CNT and PFDD/CNT composite materials were heavily doped by Ag⁺. Interestingly, FIG. 4A and4B also show that the S11 and S22 peaks were partially recovered, with the intensities increasing to about 70% of the intensities observed in the un-doped samples, when the film was soaked in ethanol for 10 min. This result indicates that the CNTs doping level was reduced by EtOH soaking, probably indicating some doping reagent was removed during soaking. It is unlikely that the removed reagent is the Ag-OTf itself since Ag⁺ is chelated with the BPy unit in the PFBPy/CNT composite and cannot be removed by EtOH washing.

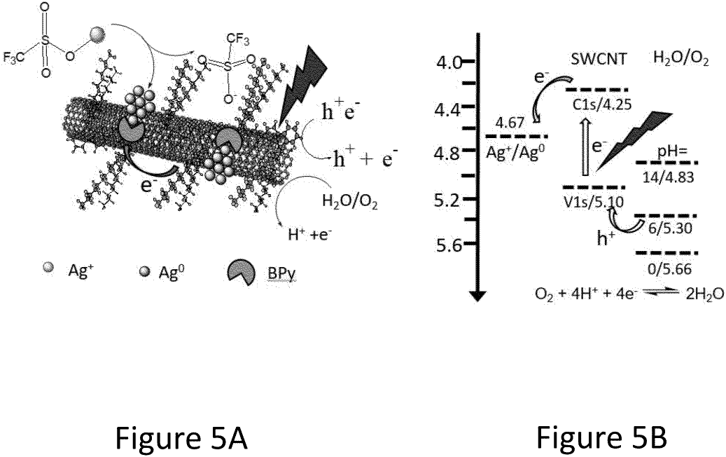

Referring now to FIGS. 5A and 5B, the recovery of the S11 and S22 peak intensities are associated with the reduction of Ag⁺ under light irradiation. The light excites the HOMO electron of the CNTs to LUMO, with an energy high enough to reduce the Ag⁺ adsorbed on the nanotube surface, and the Ag⁺ reduction can be expressed as:

$${\text{Ag-OTf ====> Ag}}^{0} + \text{-OTf} \qquad \text{(1)}$$

In this reaction, the formed -OTf ion was adsorbed on AgNP and nanotube surface to balance the hole generated by light excitation. The EtOH wash removes H-OTf from the nanotube surface with elimination of H⁺, thus raising the pH value on the nanotube surface. This process will eventually reduce the p-doping of the nanotubes, which was regulated by pH level through the H₂O/O₂ redox pair, and results in a partial recovery of the S22 peaks.

This theory has been verified by doping the PFBPy/CNT film with H-OTf, with the resulting absorption spectra shown in FIG. 4C. As will be apparent, the H-OTf doping and EtOH soaking generated a very similar effect as was observed with the Ag-OTf doping, confirming the EtOH soaking removed H-OTf from the nanotube surface and then reduced the p-doping. This interaction is also reflected by the variation of the polymer absorption peak. As shown in the inset of FIG. 4A, the addition of Ag-OTf broadened and shifted the PFBPy peak from 387 \. 0 nm to 397 \. 5 nm, indicating an Ag⁺ coordinating with BPy unit, while the peak returned to 387.0 nm after EtOH washing due to the removal of H-OTf after Ag-OTF was reduced by light catalyzation.

Further, FIG. 4D shows that EtOH soaking did not produce apparent changes to the Ag-OTf doped PFBPy film when the CNT is not present, although the doping did induce polymer peak broadening and red-shift due to the formation of an Ag complex with the BPy. This result suggests that the presence of the CNT contributes to the reduction of Ag⁺. Indeed, a kinetic study conducted by the inventors has demonstrated that the charge transfer for Ag⁺ reduction is about 100 times larger in the PFBPy/CNT solution compared to the PFDD/CNT solution. However, the charge transfer for Ag⁺ reduction only increased by 5 times upon adding 1 eq of 2,2-BPy ([BPy]/[FDD]=1/1) to the PFDD/CNT solution. These results suggest that both BPy chelating interaction with Ag⁺ and the π-π interaction of the wrapping polymer with CNT are necessary for an efficient charge transfer between the metal and the CNT.

### Cyclic Voltammetry (CV) Study

The interaction between the silver, polymer, and CNT components in both Ag-PFDD/CNTs and Ag-PFBPy/CNTs composite samples was studied by CV measurement, where the Pt working electrode was coated with the polymer, polymer/CNT composite or Ag-polymer/CNT composite.

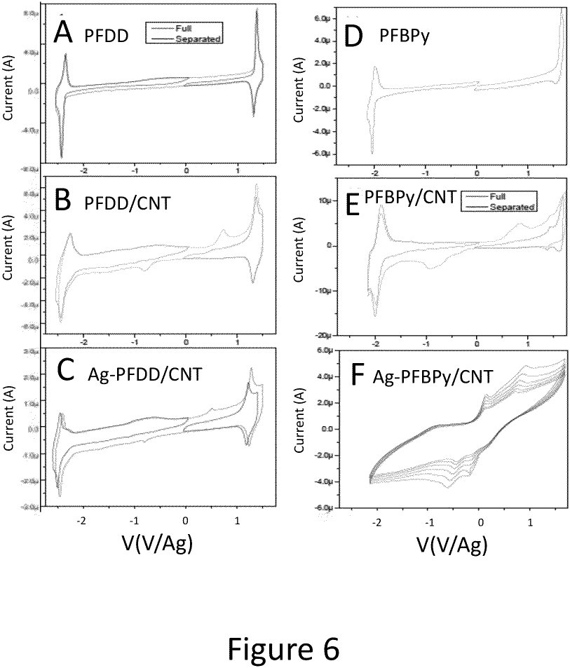

FIGS. 6A to 6C show the CV curves of the PFDD samples at three different compositing states. The CV curves for pure PFDD film shown in FIG. 6A displayed a highly reversible reduction and oxidation process for both whole range scan and separated scan of either reduction or oxidation, indicating a high stability of this polymer for both negative and positive charging. As CNTs were introduced into the polymer, an additional small peak appeared at -0.79 V in the reduction scan with an onset at -0.50 V as shown in FIG. 6B. A counter peak was also observed in the oxidation scan at +0.7 V with an onset at 0.35 V (not shown). However, both peaks disappeared in the second and successive scans when the CV was conducted in the separated oxidation and reduction range.

To further investigate the nature of these two newly emerged peaks, the sample was then scanned in the whole region of the reduction and oxidation, and these two new peaks reappeared and stayed in all the successive scans. These two new peaks are associated with the reduction and oxidation of the CNTs in the composite. The SWCNTs used in this study were laser tubes with diameters between 1.2 and 1.4 nm. The band gap of 0.85 eV calculated from these onset data is consistent with the predicted band gap value. However, FIG. 6B showed only cathodic peaks for both reduction and oxidation, while the anodic waves do not appear. This can be explained by charge trapping. During the CV scan, CNTs can hold the injected charges in this CNT/polymer composite, and they were neutralized when the opposite charges were injected in the reverse redox process. This also explained why the cathodic peak only appeared in the first scan when the sample was scanned for the oxidation and reduction separately. In this case, the tubes were charged by the cathodic injection with a saturated charging, and thus no more charge can be injected in the successive scans in the separated scans.

After Ag-OTf was added, the CV curve in FIG. 6C still show a clear cathodic peak for CNT reduction and oxidation at a similar position compared with the film without the added Ag salt. However, the peak intensity of CNTs is apparently reduced in FIG. 6C. This is thought to be because part of the nanotubes are n-doped by the formed AgNPs, as will be discussed further in the context of the TFT characterization below, which occurs when an electron is donated by the AgNPs into the CNT in the moisture and oxygen free environment. However, FIG. 6C does not show any silver redox peak for the Ag-PFDD/CNT composite. It should be noted that Ag⁺ in this sample is added in the form of Ag-OTf. As soon as the Ag-PFDD/CNT coated electrode was immersed into the CV solution, Ag-OTf itself will migrate into the solution, and the formed AgNP will also migrate into solution as soon as it is oxidized during the CV scan. Due to the large volume of the electrolyte solution (~4 mL) and the small amount of the coated film (~0.04 µL), the Ag⁺ concentration will be diluted by more than ~ 10⁵ times and thus no Ag⁺/Ag⁰ redox peak can be detected. On the other hand, AgNPs in this PFDD composite is formed by a simple photo-chemical deposition usually with a loose contact based on week Van der Waals interactions. This type of loose contact of AgNPs with carbon nanotube is commonly observed in most AgNPs decorated CNT/polymer composites to result in low synergic effects.

FIGS. 6D to 6F show the CV curves of the PFBPy samples at different compositing states. As will be apparent, the CV behaviors of the pure PFBPy and its CNT composite shown in FIGS. 6D and 6E are quite similar to the behaviors of the PFDD counterparts shown in FIGS. 6A and 6B, with two main differences. Firstly, both the reduction wave and oxidation wave of the polymer have about 0.45 V positive shift, indicating an easier electron accepting capability comparing to PFDD due to the presence of BPy unit in the polymer. Secondly, the oxidation waves of the polymer are semi-reversible, indicating the positive charge state of this polymer is less stable. FIG. 3E shows that a shoulder peak appeared at the inner side of the CNTs cathodic peak for both reduction and oxidation process of CNTs, indicating that CNTs become easier for both electron and hole injection with PFBPy wrapping. Interestingly, after 0.4 equivalent of Ag⁺ (related to the amount of BPy unit) was introduced into the composite, the polymer redox behavior was significantly changed without any polymer reduction and oxidation peak appearing. But the cathodic peak of CNTs for both reduction and oxidation remained. In contrast to the Ag-PFDD/CNT composite, a clear silver redox pair with almost symmetric cathodic and anodic peak was displayed for the Ag-PFBPy/CNT composite as shown in FIG. 3F, indicating that it is much easier for the AgNPs in this composite to receive or donate electrons and the BPy unit in the polymer can efficiently hold the formed Ag⁺ on site for future reduction. This result demonstrates a significant improvement of the robustness of the Ag/CNT composite by using PFBPy to chelate Ag⁺ on the nanotube surface upon the redox reaction. The BPy unit in the polymer anchors silver on the nanotube surface tightly to enhance the charge transfer process between them, which is beneficial when using such materials for catalysis and for sensor applications.

### XPS Study

The interaction between the silver, polymer, and CNT components in the Ag doped polymer/CNT composite was also studied using XPS. For this purpose, six film samples were prepared by coating the corresponding solutions on an aluminum plate, which included PFDD materials at three different composition stages and PFBPy materials at three different composition stages. In each case, the composition stages were pure polymer, polymer/CNT, and Ag-polymer/CNT, where the Ag-OTf doped samples have 0.0183 of [Ag]/[CNT], corresponding to 0.4 of [Ag]/[BPy] for the PFBPy composite.

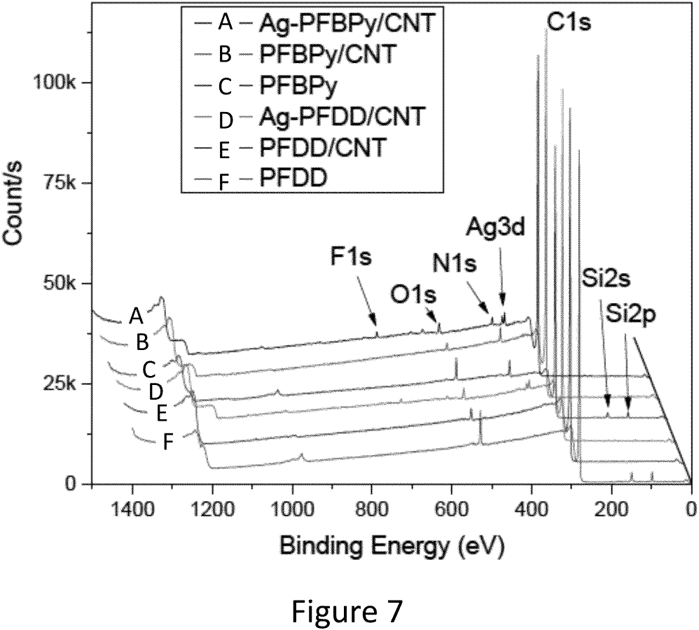

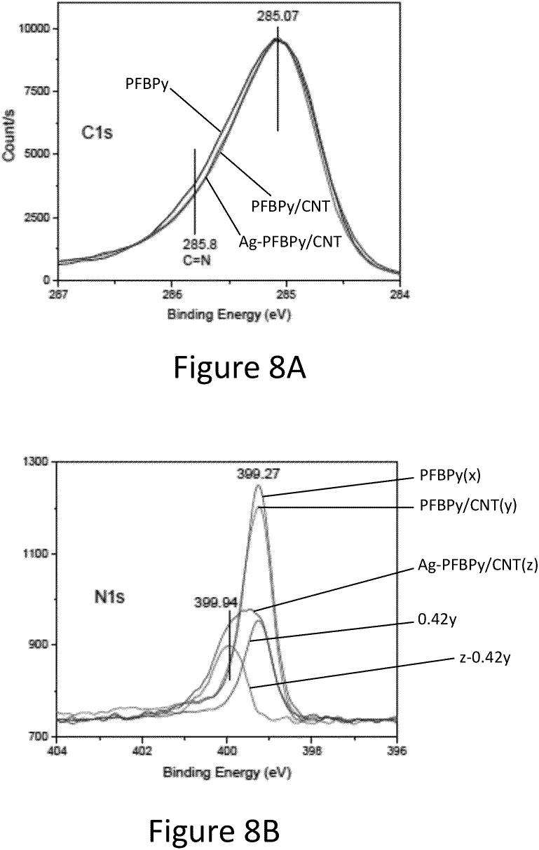

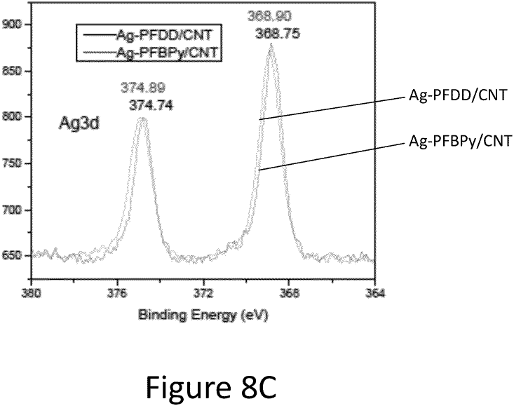

The XPS survey scan shown in FIG. 7 confirmed the existence of N in the three PFBPy samples and the presence of Ag and F elements in the Ag-OTf doped composite. FIG. 8A shows the C1s peak in both PFBPy/CNTs and Ag-PFBPy/CNTs is narrower than the pure polymer, with FWHM reduced from 1.01 to 0.92 eV. This narrowing indicates the nitrogen of PFBPy on the CNT surface has a more uniform chemical environment, and this uniformity is not disturbed by the Ag coordination. This change can be explained by the conformation change of the polymer as soon as it wrapped on the nanotubes. It is well known that the BPy unit in a free state will take both cis- and trans-conformation. A computer modeling study indicated the trans-conformation is more stable than cis- in a solution due to the higher steric hindrance of the cis-structure. However, the trans-conformation will convert to cis- on some solid surfaces, such as on silver surface, even when the surface was covered with a self-assembly monolayer. A later study showed a positive charge on this type of surface is necessary for this trans- to cis-conversion, where the nitrogen lone pair electrons on the BPy are attracted by the positive charged surface to re-orient the BPy unit to cis-conformation. It should be noted that CNTs are usually positively charged the by O₂/H₂O redox pair in air, and thus the doped nanotubes are able to induce this trans-conformation to cis-conformation conversion as soon as the polymer is packed on the nanotube surface. This process will facilitate the Ag coordinating reaction when Ag-OTf is introduced into the PFBPy/CNTs solution.

FIG. 8B compares the N1s peak of the three PFBPy materials, showing that there is almost no change after the polymer is composited with CNTs, which indicates the absence of any chemical interaction between the polymer and the nanotubes. However, the spectrum was broadened significantly at the higher binding energy side after Ag-OTf was added to the composite. This peak can be well resolved by two components at 399.27 and 399.94 eV, corresponding to the free BPy and Ag coordinated BPy in the polymer. It should be noted that the interaction of the BPy unit with metal and metal ion has a similar effect on N1s spectrum, due to the presence of oxide layer on the surface of metal or metal nanoparticles. The integrated areas of the two spectral components has a 52/48 ratio. Given that the feed ratio of [Ag]/[BPy] is 0.4/1, then if an Ag⁺ coordinates with only one BPy unit the expected ratio of free BPy to coordinated BPy is 60/40, which is close to the observed value for the above-mentioned two spectral components, indicating most of Ag atoms only form 1:1 coordination with the BPy unit in the polymer. If Ag+ chelate more than one BPy, this site will become a crosslinking point and this reaction will precipitate the solid materials out of the solution. The fact the stable solution was maintained after Ag-OTf addition indicates a 1:1 coordination mostly occurred in the solution.

The coordinating interaction was also confirmed based on the Ag3d spectra of the Ag-OTf added samples. FIG. 8C compares the Ag3d double peak of the Ag composite samples for PFDD/CNT and PFBPy/CNT. It shows the Ag3d peaks of the Ag-PFBPy/CNT sample have 0.1~0.2 eV shift to higher binding energy with 0.1 eV increase of FWHM compared to the Ag-PFDD/CNT sample. This result agrees well with the TEM study in the following section, showing that the PFBPy sample has a much smaller AgNPs size compared to the PFFD sample. A previous study reported a binding energy increase when the AgNPs become smaller than 4 nm. A similar phenomenon was observed with another noble metal, Pd.

### TEM Investigation

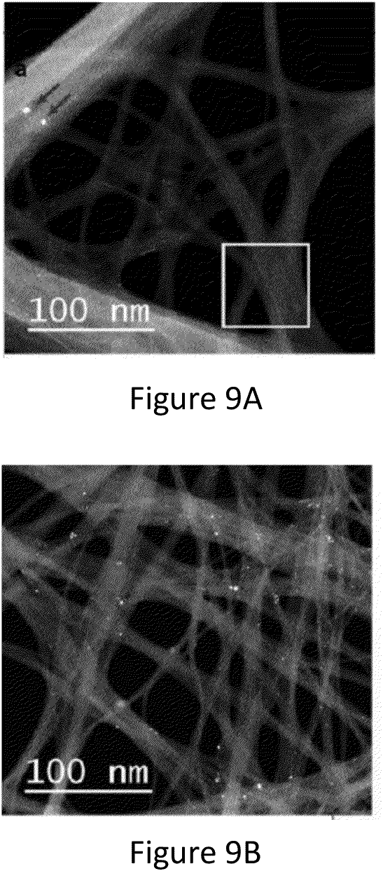

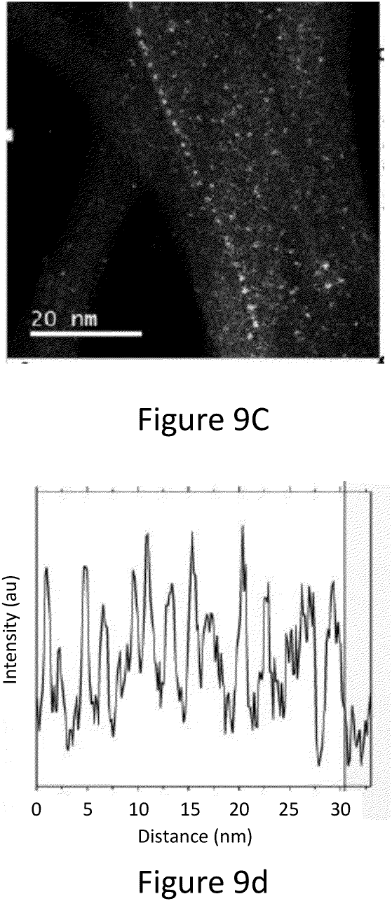

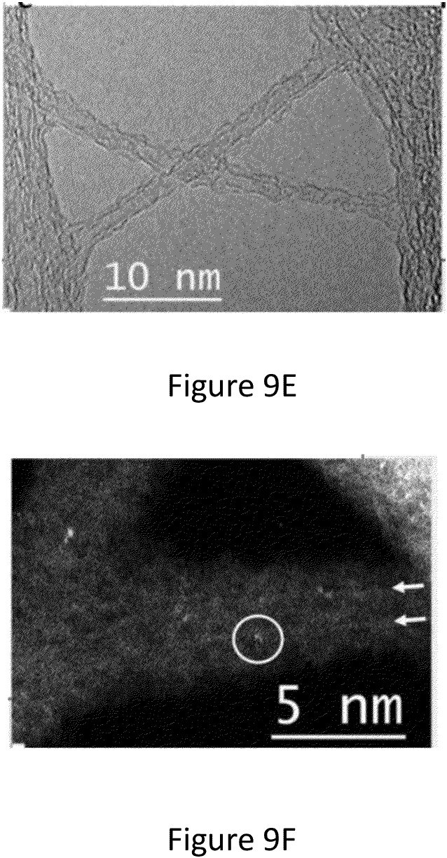

Referring to FIGS. 9A to 9F, shown are HRTEM and ADF images of the Ag-polymer/CNTs composites were taken on Lacey carbon film coated copper grids. In order to obtain sufficient contrast for nanotube with a diameter of ~1.3 nm, only the images in the hole of the carbon supporting film was taken. Due to the non-supporting in the imaging area, only the nanotubes in aggregate can be suspended to give a stable image under the impact of high energy electron beam. FIGS. 9A and 9B show ADF-STEM images of Ag-PFBPy/CNT composite and Ag-PFDD/CNT composite, respectively, where high-angle annular dark-field (HAADF) Fischione detector in scanning transmission electron microscopy (STEM) mode was used. FIG. 9C is an enlarged image of the area within the white square of FIG. 9A, showing the AgNPs chain. FIG. 9D is a density graph of AgNPs chain shown in FIG. 9C. FIG. 9D is a HRTEM image of the Ag-PFBPy/CNT composite showing the wall of the nanotubes and the wrapping polymer. FIG. 9F is a high magnification HRTEM image of Ag-PFBPy/CNT at a thinner area, using a low pass filter to show the nanotube walls and the single atoms such as the one marked by the white cycle.

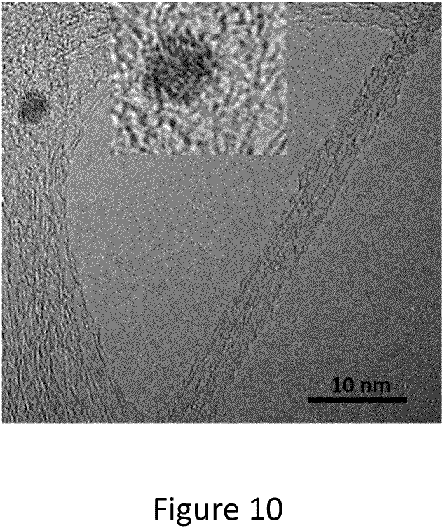

In the conventional HRTEM image of Ag-PFBPy/CNT shown in FIG. 9E, single nanotubes can be seen between large bundles. A polymer layer is clearly visible on the nanotube surface, indicating good polymer wrapping on the CNTs. However, the AgNPs are not visible in this image due to insufficient contrast. The sample was therefore observed under dark field mode, shown in FIG. 9A. The image of Ag-PFDD/CNT observed under dark field mode is also shown in FIG. 9B for comparison. As shown in FIG. 9B, a number of bright dots in the size range 1 nm to 5 nm are visible in the Ag-PFDD/CNT sample, which are the silver nanoparticles. However, AgNPs in this size are rarely seen in the Ag-PFBPy/CNT image in FIG. 9A. In fact, only two AgNPs in the 1 nm to 5 nm size range were observed in this image, which are indicated by arrows in FIG. 9A. A high magnification conventional TEM image of a similar bright dot is shown in FIG. 10. The inset of FIG. 10 clearly shows lattice fringes, indicating that the bright dots are metallic particles of about 3 nm in size.

A close examination of FIG. 9A reveals a large number of small bright dots in this sample, including a “chain” comprising more than 60 bright dots uniformly dispersed along the nanotube aggregate. Images these small dots were taken with higher magnification and are shown in FIGS. 9C and 9F, revealing particles with sub-nm size and even single silver atoms. The enlarged area imaged in FIG. 9C, and the graphic analysis of the chain of dots shown in FIG. 9D, indicate an average particle size of 0.6 nm and an average separation between two adjacent particles of ~1.7 nm, which agrees with the distance of two adjacent BPy units in the polymer chain. This result indicates that the BPy unit of the wrapping PFBPy polymer bound the Ag⁺ and anchored the AgNPs on the nanotube surface. However, the distance between the adjacent AgNPs in FIG. 9C is not entirely uniform, which may be due to the preferential growth of nanoparticle on certain crystal planes.

It should be noted that, during the preparation of the samples, the Ag-OTf solution was slowly added to the polymer/CNT composite solution without stirring. Therefore, the Ag-OTf molecules slowly diffused into the solution. Larger sized AgNPs may have formed in regions with a locally high Ag⁺ concentration close to the location Ag-OTf droplets entered the composite solution. The Ag⁺ is first coordinated with the BPy unit in the polymer and is then reduced by the electrons donated from CNTs. The resulting Ag atom may act as a seed for 2nd, 3rd and more Ag⁺ depositing from the bulk solution and being similarly reduced to eventually form an AgNP. In this way, the AgNPs can be formed on the CNT surface with locations that are fixed by the BPy units of the wrapping PFBPy and the size of the NPs is regulated by the diffusion of Ag-OTf molecules in the solution. Of course, as soon as the Ag⁺ becomes coordinated with BPy, the Ag⁺ will have a diminished mobility and thus the accumulation of Ag⁺ on the formed NPs will significantly slow down. This is believed to be the reason for the formation of predominantly NPs having a small average size of ~ 0.6 nm in the Ag-PFBPy/CNT samples, in view of the fact that only 0.4 of [Ag]/[BPy] was used. These observations also indicate that the Ag⁺ coordination with BPy is a faster process than Ag⁺ reduction. It is theorized that the Ag⁺ coordination is facilitated by the trans- to cis-conformation conversion of the BPy unit of the polymer when it wraps onto a nanotube, as confirmed by the XPS study.

In contrast, the AgNPs that are observed in the Ag-PFDD/CNT composite (FIG. 9B) are rarely as small as the AgNPs that are observed in the Ag PFBPy/CNT composite (shown in FIG. 9A), and tend to be in the size range from about 1 nm to 5 nm. This is believed to be because the AgNPs in the Ag-PFDD/CNT sample were formed by a simple diffusion-controlled Ag⁺ reduction in room light. As soon as an Ag⁰ seed forms on the CNT surface, it has a chance to receive more Ag⁺ from the bulk solution until the Ag⁺ is completely consumed by the reduction. Therefore, it is apparent that the efficient coordinating reaction of BPy with silver cations in the Ag-PFBPy/CNT composite not only tightly anchors the AgNPs on the CNT surface, but also regulates the concentration of free Ag⁺ and thus effectively controls the AgNP size to be at the sub-nm level.

### 5. Sensor Test

The combination of highly dispersed nanoparticles in the sub-nm size range and strong π-π interaction between the conjugated polymer and the CNTs make Ag-PFBPy-CNT and other similar composite materials promising candidates for sensing and catalyst applications. Improved sensing and catalyst performance may be expected due to the large surface area of the material combined with efficient charge transfer between the NPs and the CNTs through the coordinating and π-π interactions. In order to further explore the potential of such composite materials for sensing applications, two examples were investigated as outlined below.

### Example 1: Humidity Sensing Using Ag-PFBPy/CNT

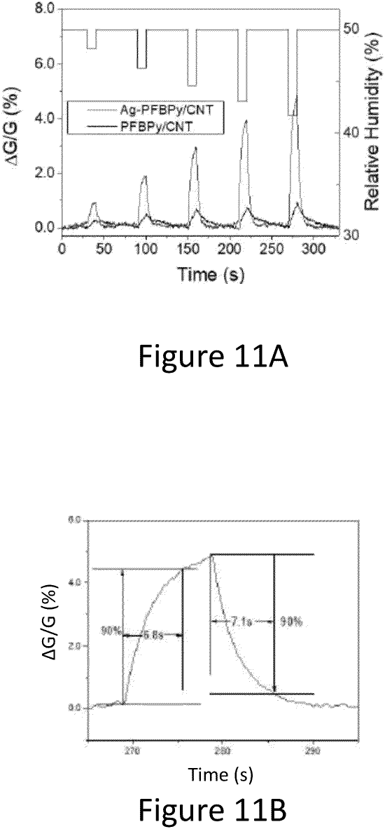

The humidity sensing behavior of chemiresistors at ~50% RH for Ag-PFBPy/CNT was compared to a control device, which consisted of the same composite material but without AgNPs. FIG. 11A compares the response (ΔG/G0) curve of Ag-PFBPy/CNT and PFBPy/CNT devices to an air pulses sequence with lower RHs (48.1, 46.3, 44.6, 43.1 and 41.7%). The device responses (ΔG/G0(%)) were recorded as the conductance increase of the respective device using Eq2:

$$Δ \text{G} / {\text{G}}_{0} \left(\%\right) = \left({\text{I-I}}_{0}\right) / {\text{I}}_{0} \times 100 \left(\%\right) \qquad \text{(2)}$$

where I₀ and I are the current of the sensor before and after exposure to the dry air pulse. FIG. 11A shows that the response of the Ag-PFBPy/CNT device is about 5 times the response of the control device without AgNPs, where only ~1% response was observed when the RH changed from 50% to 41.7%. This value agrees with the reported results of semiconducting carbon nanotube devices, which is ~2% difference of the response in sensing 40% and 50% RH air.

These results indicated an apparent enhancement of the sensing response by introducing AgNPs onto the surface of CNTs via the conjugated polymer. Further, as shown in FIG. 11B, the response and recovery times are about 6.8 s and 7.1 s, respectively. These values are much shorter than the values obtained using the control device without AgNPs, which were about 9 s and 37 s, respectively.

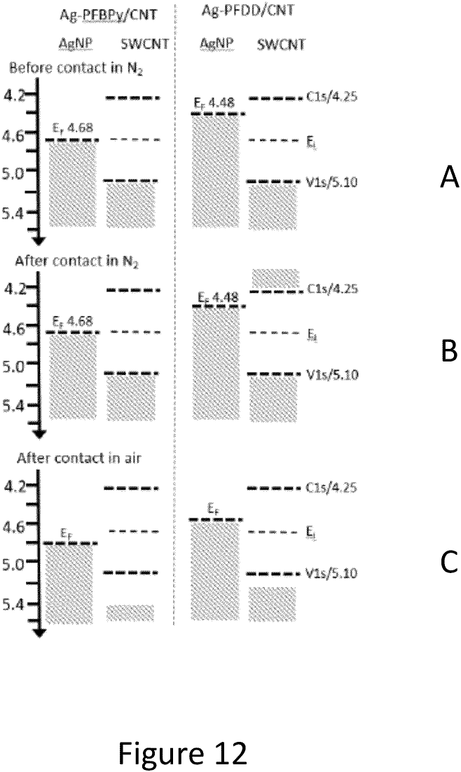

The improved sensing capability of the Ag-PFBPy-CNT composite may be understood by examining the charge interaction on the Ag/CNT interface in both the PFBPy and PFDD composites. The Fermi level of AgNPs with the energy level of CNTs was compared in FIG. 12 for Ag-PFBPy/CNT and Ag-PFDD/CNT composite, where part A shows the energy levels before contact in N₂, part B shows the energy levels after contact in N₂, and part C shows the energy levels after contact in air.

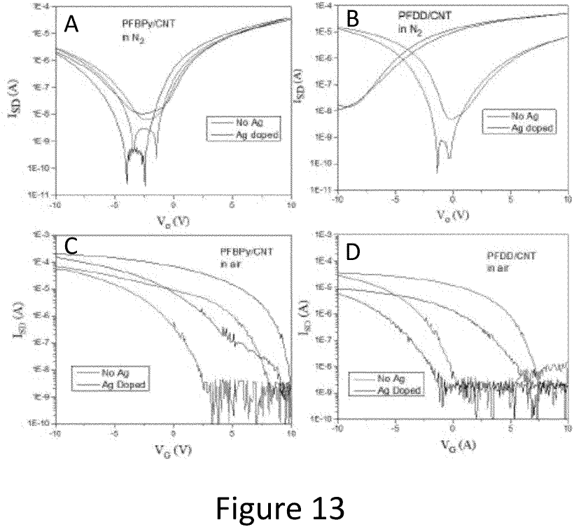

It is generally observed that a metal nanoparticle has a higher work function than its polycrystalline metal. The work function of silver nanoparticles have been reported in a wide range, for example with a particle size of ~5 nm, the reported work function values vary between 4.09 and 5.50 eV depending on the type of ligands on the surface and detection methods used. For the purpose of this discussion, a value for the AgNPs will be estimated based on the TFT study. As shown in FIG. 13A, the Ag-PFBPy/CNT device in dry N₂ has almost the same transfer curve as the device without AgNPs (i.e., PFBPy/CNT), indicating that in this AgNP device there is not an obvious charge flow between AgNPs and CNTs. This result means the Fermi level of AgNPs in this device is at the same level of CNTs. Based on the fact that the PFBPy/CNT composite has an almost symmetric ambipolar n-/p-branches in its transfer curve, the Fermi level is approximately the median of V1s and C1s of the CNTs, which are reported 5.10 and 4.25 eV respectively for the laser CNTs with an average diameter of 1.3 nm. This results in an estimated Fermi energy for the AgNPs of ~4.68 eV, which is larger than the value of polycrystalline Ag. The large value estimated for the Fermi energy is attributed to the very small size of the AgNPs (~1 nm) and the adsorption of the OTf ligand. This can be confirmed by the TFT performance of the Ag-PFDD/CNT device. Referring now to FIG. 13B, as the AgNPs were introduced to the PFDD/CNT composite the material converted from ambipolar to n-type. The HTEM results discussed previously with reference to FIG. 9B show that the AgNPs in this composite are much larger (5 nm vs. 0.6 nm). This will result in about 0.2 eV work function decrease of AgNPs, meaning the Fermi level was reduced from 4.68 to 4.48 eV in the Ag-PFDD/CNT composite. The equilibrium of the Fermi level of AgNPs with CNT in the Ag-PFDD/CNT composite will result in electron flow from AgNPs to CNT and lead to n-doping of CNTs as shown in part B of FIG. 12.

On the other hand, FIGS. 13C and 13D show that both devices in ambient air have completely different transfer curves than in N₂. Both devices displayed a typical p-type behavior, indicating that both materials are heavily p-doped. This behavior is commonly observed in CNT based TFT devices because the nanotubes are doped by the O₂/H₂O redox pair in air. FIG. 13 further indicated that the Ag doping slightly enhanced the p-current in the PFBPy composite, while slightly reducing the p-current in the PFDD composite. This is attributed the combination effect of the Fermi level equilibrating between AgNPs and CNTs and the O₂/H₂O redox doping as illustrated in part C of FIG. 12. It should be noted that the air doping effect overwhelmed the effect of Fermi level equilibrium due to the endless supply of air, while very limited charge flowed from the AgNPs because they are very small in size.

It is also reported that the work function of AgNPs is significantly affected by the ligands that are adsorbed on their surface. Up to 0.7 eV work function increase may be observed when the surface is fully covered with a highly polar ligand. This effect can significantly reduce the electron flow from the AgNPs into the CNTs with increasing ligand concentration during the Fermi level alignment. In the composite materials that are described herein, it is worth noting that the AgNPs are formed in the Ag-OTf/Polymer/CNT composite solutions by photo-reduction, and the released -OTf ligand is adsorbed on the AgNPs surface to result in an increased work function of the AgNPs. This interaction benefits the moisture sensing. In the sensing process, when the RH is reduced to a low value as the dry air pulse is introduced, the adsorbed water layer on AgNP surface will be reduced, leading to an increased concentration of OTf ligand, which in turn results in an increase of the work function of AgNPs, and thereby yielding an increase of hole concentration in the CNTs. As a result, a large ΔG/G0 can be detected, as is shown in FIG. 11A.

As such, the adsorption of water on the surface of the AgNPs plays an important role in the sensing enhancement that is observed for the Ag-PFBPy/CNT composite material. Compared to the other two components in this material, i.e., PFBPy and CNT, the AgNPs have a much more hydrophilic surface due to the covering with a thin oxide layer. The AgNP surfaces will preferentially adsorb water molecule to enhance the Fermi level change with moisture. The electric contact of the AgNPs with the CNTs will then freely deliver this signal to the CNTs.

It is therefore believed that the significant improvement of the AgNP sensor compared to the non-AgNP sensor can be attributed to at least the following factors: (1) The relative hydrophilic surface of AgNPs ensured a selective adsorption of moisture and amplified the moisture change effect. (2) The small size causes the AgNPs to possess an aligned Fermi level with the CNTs and thus provide a sensitive charge flow between them. (3) The tight anchoring of AgNPs on the CNTs surface ensured an electric contact to promote the charge transfer. (4) The large π-π interaction of the polymer main chain with the CNT further established a tight anchoring of AgNP. In fact, all of the above-mentioned factors facilitate a charge transfer channel to deliver the sensing signal from the AgNPs to the nanotubes. In addition, the specific affinity of the AgNPs in binding water molecule make this composite a highly sensitive material for humidity sensing. Finally, the AgNPs are tightly anchored on the nanotube surface via the conjugated polymer, which makes the composite material more robust for sensing applications.

### Example 2: Ethylene Sensing Using Cu(I)-PFBPy-5, 5′/CNT

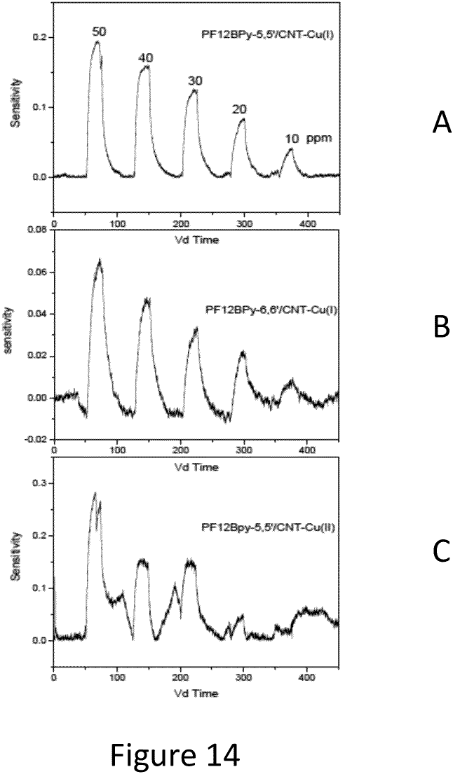

A device for sensing ethylene was prepared using a similar method, by introducing Cu(I)-OTf solution into the PFBPy-5,5′/CNT solution. For comparison, devices based on two other copper-based composite materials were also prepared. In one case, PFBPy-6,6′ was used instead of the 5,5′-copolymer. In the other case, Cu(II) was used instead of Cu(I). In all three of the copper-based sensor devices, the polymer to SWCNT ratio is 2.7, and the [Cu]/[BPy] molar ratio is 1.0. FIGS. 14A to 14C show the sensing responses of these the devices based on Cu(I)-PFBPy-5, 5′/CNT, Cu(I)-PFBPy-6, 6′/CNT and Cu(II)-PFBPy-5, 5′/CNT, respectively, to ethylene at a concentration of 50, 40, 30, 20 and10 ppm. As will be apparent, for the same ethylene concentration, the Cu(I)-PFBPy-5, 5′/CNT device has ~3 times higher response than the Cu(I)-PFBPy-6, 6′/CNT device, while the Cu(II)-PFBPy-5, 5′/CNT device did not show a regular response to the ethylene. These results suggest that the 5,5′-linkage promotes the sensing capability, and that proper metal selection is also important for sensing specific analytes.

Selectivity enhancement has been demonstrated by introducing a selector metal species into conjugated polymer wrapped on SWCNTs for binding a specific analyte in a nanotube-based resistor or TFT device. In the materials that have been investigated, the conjugated polymer wrapped on the SWCNT is poly(9,9-di-n-dodecylfluorenyl-2,7-diyl-alt-2,2′-bipyridine-5,5′), and the selector metal is coordinated to the bipyridine unit in the conjugated polymer as a way of anchoring the metal to nanotube surface and providing a charge transfer pathway.

In the description of the invention herein, it is understood that a word appearing in the singular encompasses its plural counterpart, and a word appearing in the plural encompasses its singular counterpart, unless implicitly or explicitly understood or stated otherwise. For instance, unless the context indicates otherwise, a singular reference, such as “a” or “an” means “one or more.” Furthermore, it is understood that for any given component or embodiment described herein, any of the possible candidates or alternatives listed for that component may generally be used individually or in combination with one another, unless implicitly or explicitly understood or stated otherwise. Additionally, it will be understood that any list of such candidates or alternatives is merely illustrative, not limiting, unless implicitly or explicitly understood or stated otherwise. It is also to be understood, where appropriate, like reference numerals may refer to corresponding parts throughout the several views of the drawings for simplicity of understanding.

Throughout the description and claims of this specification, the words “comprise,” “including,” “having” and “contain” and variations of the words, for example “comprising” and “comprises” etc., mean “including but not limited to,” and are not intended to (and do not) exclude other components.

It will be appreciated that variations to the foregoing embodiments of the invention can be made while still falling within the scope of the invention. Each feature disclosed in this specification, unless stated otherwise, may be replaced by alternative features serving the same, equivalent or similar purpose. Thus, unless stated otherwise, each feature disclosed is one example only of a generic series of equivalent or similar features.

The use of any and all examples, or exemplary language (“for instance,” “such as,” “for example,” “e.g.,” and like language) provided herein, is intended merely to better illustrate the invention, and does not indicate a limitation on the scope of the invention unless otherwise claimed. No language in the specification should be construed as indicating any non-claimed element as essential to the practice of the invention.

Any steps described in this specification may be performed in any order or simultaneously unless stated or the context requires otherwise.

All of the features disclosed in this specification may be combined in any combination, except combinations where at least some of such features and/or steps are mutually exclusive. In particular, the preferred features of the invention are applicable to all aspects of the invention and may be used in any combination. Likewise, features described in non-essential combinations may be used separately (not in combination). Numerous other embodiments may be envisaged without departing from the spirit or scope of the invention.

What is claimed is:

1. A composition comprising:
a carbon nanotube;
a conjugated polymer non-covalently bound to the carbon nanotube, the conjugated polymer having alternating aromatic (Ar) units and bipyridine (BPy) units; and
metal nanoparticles, each having a size between about 0.3 nm and about 5 nm, bound to the conjugated polymer at respective BPy units thereof.

2. The composition of claim 1, wherein the carbon nanotube is a single-walled carbon nanotube (SWCNT).

3. The composition of claim 1, wherein the metal nanoparticle each have a size that is larger than about 0.3 nm and smaller than about 1 nm.

4. The composition of claim 1, wherein the conjugated polymer has the general formula I: 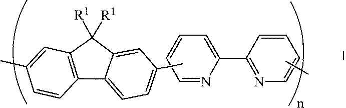
wherein:
R¹ and R² are independently C₁₀-C₂₄ branched or unbranched aliphatic, oligo(ethoxy) or oligo(methoxy) groups; and
n is between 5 and 500.

5. The composition of claim 4, wherein linkage to BPy is at the 5,5′ positions.

6. The composition of claim 1, wherein Ar is selected from the group consisting of: naphthalene, anthracene, fluorene, carbazole, phenylene, furan, benzofuran, isobenzofuran, pyrrole, indole, isoindole, thiophene, bithiophene, benzothiophene, benzo[c]thiophene, imidazole, benzimidazole, purine, pyrazole, indazole, oxazole, benzoxazole, isoxazole, benzisoxazole, thiazole, benzothiazole, pyridine, bipyridine, quinolone, isoquinoline, pyrazine, quinoxaline, acridine, pyrimidine, quinazoline, pyridazine, cinnoline, phthalazine, tetrazine, triazine, benzothiadiazole, and combinations thereof.

7. The composition of claim 1, wherein the metal nanoparticles are nanoparticles of a metal selected from the group consisting of: Ag, Cu, Co, Ni, Mn, Fe, Zn, In, Pd, Cr, Sn, Cd, Ir, and Ru.

8. The composition of claim 1, wherein Ar is 9,9-di-n-dodecylfluorene, linkage to BPy is at the 5,5′ positions, and the metal nanoparticle is a silver nanoparticle or a copper nanoparticle having a size in the range between about 0.5 nm and about 1.5 nm.

9. A method of making a composition, the method comprising:
non-covalently binding a conjugated polymer to a carbon nanotube to form a polymer-wrapped composite, the conjugated polymer comprising alternating aromatic (Ar) units and bipyridine (BPy) units;
in a solution, adding metal ions to bind with the BPy units of the conjugated polymer;
irradiating the solution with light to reduce the metal ions and form seed locations for nanoparticle growth at the BPy units; and
growing nanoparticles at the seed locations to a size in the range between about 0.3 nm and about 5 nm.

10. The method of claim 9, wherein the carbon nanotube is a single-walled carbon nanotube (SWCNT).

11. The method of claim 9, wherein growing the nanoparticles comprises growing the nanoparticles to a size that is larger than about 0.5 nm and smaller than about 1 nm.

12. The method of claim 9, wherein the step of non-covalently binding the conjugated polymer to the carbon nanotube includes dispersing the conjugated polymer and the carbon nanotube in a non-polar solvent.

13. The method of claim 12, wherein the non-polar solvent is toluene.

14. The method of claim 12, comprising:
separating the polymer-wrapped composite from the non-polar solvent to remove free polymer from solution; and
redispersing the separated polymer-wrapped composite in tetrahydrofuran to form the solution.

15. The method of claim 9, wherein the metal ion (M) is added to the solution to produce a molar ratio [M]/[BPy] of about 0.1 to about 50.

16. The method of claim 15, wherein the molar ratio [M]/[BPy] is about 0.4 to about 5.

17. The method of claim 9, wherein the conjugated polymer has the general formula I: 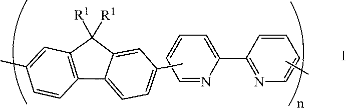
wherein:
R¹ and R² are independently C₁₀-C₂₄ branched or unbranched aliphatic, oligo(ethoxy) or oligo(methoxy) groups; and
n is between 5 and 500.

18. The method of claim 9, wherein Ar is selected from the group consisting of: naphthalene, anthracene, fluorene, carbazole, phenylene, furan, benzofuran, isobenzofuran, pyrrole, indole, isoindole, thiophene, bithiophene, benzothiophene, benzo[c]thiophene, imidazole, benzimidazole, purine, pyrazole, indazole, oxazole, benzoxazole, isoxazole, benzisoxazole, thiazole, benzothiazole, pyridine, bipyridine, quinolone, isoquinoline, pyrazine, quinoxaline, acridine, pyrimidine, quinazoline, pyridazine, cinnoline, phthalazine, tetrazine, triazine, benzothiadiazole, and combinations thereof.

19. The method of claim 9, wherein the metal nanoparticles are nanoparticles of a metal selected from the group consisting of: Ag, Cu, Co, Ni, Mn, Fe, Zn, In, Pd, Cr, Sn, Cd, Ir, and Ru.

20. A sensor for sensing an analyte in a gaseous medium, the sensor comprising a sensing material disposed between two electrodes, the sensing material comprising:
a carbon nanotube;
a conjugated polymer non-covalently bound to the carbon nanotube, the conjugated polymer having alternating aromatic (Ar) units and bipyridine (BPy) units with the general formula I: 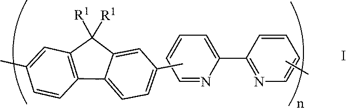
wherein:
R¹ and R² are independently C₁₀-C₂₄ branched or unbranched aliphatic, oligo(ethoxy) or oligo(methoxy) groups; and
n is between 5 and 500; and
nanoparticles of a metal selected from the group consisting of: Ag, Cu, Co, Ni, Mn, Fe, Zn, In, Pd, Cr, Sn, Cd, Ir, and Ru, each nanoparticle having a size between about 0.3 nm and about 5 nm, the nanoparticles bound to the conjugated polymer at respective BPy units thereof.
